(19) United States
(12) Patent Application Publication
(10) Pub. No.: US 2007/0210654 A1
(43) Pub. Date: Sep. 13, 2007

(54) Motor

(75) Inventors: Satoshi Ueda, Kyoto (JP); Tadayuki Kanatani, Kyoto (JP); Hiroaki Sasaoka, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NIDEC CORPORATION, Kyoto (JP)

(21) Appl. No.: 11/714,164

(22) Filed: Mar. 6, 2007

(30) Foreign Application Priority Data
Mar. 7, 2006 (JP) 2006-060586

(51) Int. Cl. H02K 5/24; H02K 7/00; H02K 5/16

(52) U.S. Cl. 310/51; 310/67 R; 310/90

(57) ABSTRACT

An object of the present invention is to provide a motor capable of enhancing the balance correction effect and capable of keeping the balance correction effect for a long term.

In a rotary unit, an upper portion in its axial direction of a hub cylindrical portion of a rotor hub, and an outer peripheral side of a radial extension are cut, thereby correcting the rotational balance of the rotary unit. Further, a circumferential wall is provided on the rotor hub, and a notch is provided in a portion of an outer peripheral edge of a mounting plate. By virtue of such configuration, after the motor is assembled, or after a color wheel is mounted on the motor, a first balance correcting member and a second balance correcting member are respectively fixed to lower surfaces of the circumferential wall and of the rotor magnet in the axial direction, thereby correcting the rotational balance.

### BACKGROUND OF THE INVENTION

1. Field of the Invention

The present invention relates to a motor for rotating a disc, a color wheel and the like, and more particularly, to a correcting structure and a correcting method of a rotational imbalance of the motor.

2. Description of the Related Art

Conventionally, a motor mounted in a picture equipment has a problem that, due to a long continuous using time of the picture equipment, an operating life of the motor must be increased. Generally, the operating life of the motor is determined by an operating life of a bearing therein. For example, in a case of a fluid dynamic pressure bearing, the operating life of the bearing is determined by an amount of lubricant oil which is a medium for generating the dynamic pressure. However, the operating life of the bearing will be reduced due to evaporation of the lubricant oil, or due to the rotational imbalance, whereby the bearing will be overloaded, and there will be a possibility that the bearing will be damaged. Such damage may cause seizing of the motor. Especially in a dynamic pressure bearing using gas such as air as a medium for the rotation, contact between bearing elements will be generated when the rotational balance is deteriorated even slightly. Thus, seizing of the bearing is easily occurred. In order to prevent the rotational balance from being deteriorated, various correcting methods of the rotational imbalance of the motor have been developed. When a two-surface balance correction at two separate locations in an axial direction of the motor is executed for correcting a rotational imbalance, the rotational balance can be achieved (see Japanese Patent Application Laid-open No. 2002-58225 as patent document 1 for example for a conventional two-surface balance correction structure).

In the two-surface balance correction, the greater the distance in the axial direction between the locations at which the correction is executed, the greater the effect of the correction becomes.

However, in such two-surface balance correction is executed on a motor having a conventional structure, the distance between the balance correcting locations is short in the axial direction, and therefore, an effect of the balance correction is small. Further, according to the conventional correction method, since nothing is provided on the outer periphery of the balance correcting member, there is a possibility that the balance correcting member jumps outward in the radial direction due to the centrifugal force of the motor when the motor rotates.

### SUMMARY OF THE INVENTION

A motor of the present invention includes a stator unit and a rotary unit which is concentrically rotatably supported by the stator unit. The rotary unit includes a notch so as to correct a rotational imbalance of the rotary unit with respect to a central axis. Also, a balance correcting member for correcting a rotational imbalance is attached to the motor in which the stator unit and the rotary unit are assembled with one another.

### BRIEF DESCRIPTION OF THE DRAWINGS

FIG. 1 is a schematic cross sectional view in an axial direction of an embodiment of a motor of the present invention.

FIG. 2 is a schematic cross sectional view in the axial direction of a rotary unit of the present invention.

FIG. 3 is a schematic cross sectional view in the axial direction of a state where a balance correction of the motor of the present invention is carried out.

FIG. 4 is a bottom view of the motor of the present invention in the axial direction of the mounting plate as viewed from a lower surface.

FIG. 5 is a schematic cross sectional view in the axial direction of a state where a balance correction is carried out in a state where a color wheel and a clamp member are mounted on the motor of the present invention.

FIG. 6 is a flowchart showing a balance correcting method of the present invention.

FIG. 7 is a schematic cross sectional view in the axial direction of another embodiment of the motor of the present invention.

### DETAILED DESCRIPTION OF THE PREFERRED EMBODIMENTS

### <Structure of a Motor>

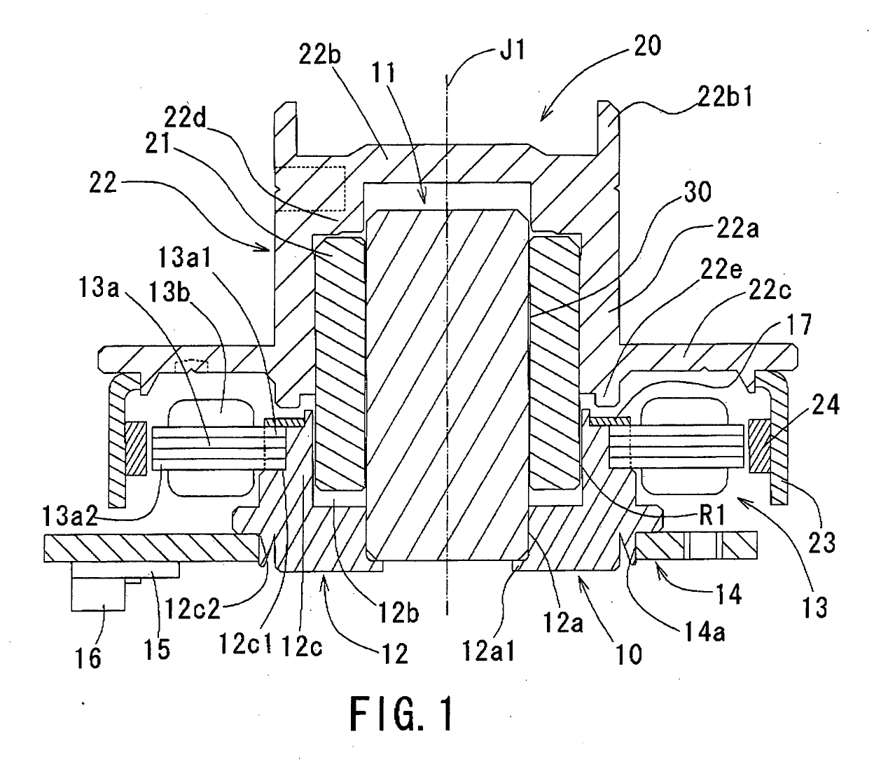

An example of a preferred embodiment of a motor according to the present invention will be described with reference to FIG. 1. FIG. 1 is a schematic cross sectional view in an axial direction of the motor. Note that in the description of the preferred embodiment of the present invention herein, words such as upper, lower, left, right, upward, downward, top, and bottom for explaining positional relationships between respective members and directions merely indicate positional relationships and directions in the drawings. Such words do not indicate positional relationships and directions of the members mounted in an actual device. Also note that reference numerals, figure numbers and supplementary explanations are shown below for assisting the reader in finding corresponding components in the description of preferred embodiments below to facilitate the understanding of the present invention. It is understood that these expressions are in no way intended to restrict the scope of the invention.

Referring to FIG. 1, the motor according to the preferred embodiment includes a stator unit 10, a rotary unit 20 which relatively rotates with respect to the stator unit 10, and a bearing mechanism 30 arranged between the stator unit 10 and the rotary unit 20. The bearing mechanism 30 rotatably supports centering about a central axis J1 the rotary unit 20 with respect to the stator unit 10.

1) Stator Unit 10

The stator unit 10 includes a columnar shaft 11 disposed coaxially with the central axis J1, a substantially cylindrical bush 12 fixed to a lower portion of the shaft 11 in the axial direction, a stator 13 fixed to an upper portion of the outer peripheral surface of the bush 12 in the axial direction, and a mounting plate 14 fixed to a lower portion of the outer peripheral surface of the bush 12 in the axial direction.

The shaft 11 fixed to the central axis J1 is made of a ceramic material. The shaft 11 includes at an outer peripheral surface thereof a dynamic pressure generating groove (not shown) for generating dynamic pressure.

The bush 12 includes a cylindrical shaft fixing portion 12a. The shaft fixing portion 12a fixes a lower portion in the axial direction of the shaft 11. An annular projection 12a1 is provided at an inner periphery of the shaft fixing portion 12a for positioning the shaft 11 in the axial direction. It is preferable to use a press fit in order to fix the shaft 11 to the shaft fixing portion 12a. To further enhance the fixing strength between the shaft 11 and the shaft fixing portion 12a, an adhesive may be applied.

The shaft fixing portion 12a of the bush 12 includes at an upper end portion thereof a radially enlarged portion 12b extending radially outward. An outer peripheral cylindrical portion 12c extending upward in the axial direction is connectedly formed with the radially enlarged portion 12b. An upper step 12c1 for disposing the stator 13 is formed on the upper portion of the outer peripheral surface of the outer peripheral cylindrical portion 12c. A lower step 12c2 for fixing the mounting plate 14 is formed on a lower portion of an outer peripheral surface of the bush 12 which is connected to the outer peripheral cylindrical portion 12c.

The stator 13 includes a stator core 13a including a plurality (four, in the preferred embodiment) of laminated thin magnetic steel plates, and a coil 13b having a conductive wire wound around the stator core 13a. The stator core 13a includes at an inner peripheral side thereof an annular core back portion 13a1, and a plurality of tooth portions 13a2 each arranged radially outward from the core back portion 13a1. The coil 13b is formed by winding the conductive wire around the tooth portion 13a2. An axial and radial position of the core back portion 13a1 is determined by an upper surface of the upper step 12c1 of the bush 12 in the axial direction and an outer peripheral surface connected to the upper step 12c1. The bush 12 and the stator 13 are fixed to each other by interposing adhesive between the outer peripheral surface of the bush 12 and an inner peripheral surface of the core back portion 13a1 of the stator 13.

The mounting plate 14 is formed by a deformation process (e.g., press fit) using a steel plate. The mounting plate 14 includes an opening hole 14a which is engaged with the lower step 12c2 of the bush 12. An axial and radial position of the mounting plate 14 is determined by the lower step 12c2. The mounting plate 14 and the bush 12 are fixed by deforming a portion of a lower end surface of the bush 12 by the deformation process so as to sandwich the outer peripheral edge of the mounting plate 14.

A lead of the coil 13b is fixed to a lower surface in the axial direction of the mounting plate 14 by soldering, and an electrically conductive circuit substrate 15 is fixed to the lower surface by, for example, an adhesive. A connector 16 connected to an external power supply (not shown) is connected to a lower surface of the circuit substrate 15 by soldering.

2) Rotary Unit 20

The rotary unit 20 includes a substantially cylindrical sleeve 21 opposed to an outer peripheral surface of the shaft 11 with a minute gap interposed therebetween in the radial direction, a substantially cylindrical operculated rotor hub 22 fixed to the outer peripheral surface of the sleeve 21, a yoke 23 which is a magnet holding section fixed to the rotor hub 22, and a rotor magnet 24 fixed to an inner peripheral surface of the yoke 23. The yoke 23 may be integrally formed with the rotor hub 22. When the yoke 23 is integrally formed with the rotor hub 22, at least the magnet holding section of the rotor hub 22 is made of a magnetic material.

The sleeve 21 is made of a ceramic material, and therefore, even when the sleeve 21 comes into contact with the outer peripheral surface of the shaft 11, the sleeve 21 can be prevented from being damaged. The outer peripheral surface of the lower portion in the axial direction of the sleeve 21 is opposed to the inner peripheral surface of the outer peripheral cylindrical portion 12c of the bush 12 with a minute gap R1 interposed therebetween. A lower end surface in the axial direction of the sleeve 21 is opposed to an upper surface of the radially enlarged portion 12b of the bush 12 in the axial direction with a gap interposed therebetween.

The rotor hub 22 includes a hub cylindrical portion 22a having an inner peripheral surface fixed to the outer peripheral surface of the sleeve 21 via an adhesive, a lid 22b for covering an upper end in the axial direction of the hub cylindrical portion 22a, and a radial extension 22c extending radially outward formed on a lower end in the axial direction of the hub cylindrical portion 22a. An inner peripheral cylindrical portion 22d is formed at a portion of an inner peripheral surface of the hub cylindrical portion 22a above an upper end surface in the axial direction of the sleeve 21.

The inner peripheral cylindrical portion 22d has a thickness greater than a radial thickness of the hub cylindrical portion 22a which fixes the sleeve 21. The inner peripheral surface of the inner peripheral cylindrical portion 22d is superposed on the shaft 11 in the radial direction. The inner peripheral surface of the inner peripheral cylindrical portion 22d is opposed to the outer peripheral surface of the shaft 11 in the radial direction with a minute gap interposed therebetween. The lid 22b is formed continuously with the inner peripheral cylindrical portion 22d such as to cover the inner peripheral cylindrical portion 22d. The lid 22b is opposed to the upper end surface of the shaft 11 in the axial direction with a gap interposed therebetween. Even when a foreign matter is adhered to the lid 22b when the rotor hub 22 is machined, it is possible to prevent the foreign matter from entering the bearing mechanism 30 by the minute gap formed between the inner peripheral surface of the inner peripheral cylindrical portion 22d and the outer peripheral surface of the shaft 11. Therefore, it is possible to provide a reliable motor in which seizing of the bearing mechanism 30 is not generated by a foreign matter. A circumferential wall 22b1 at which the hub cylindrical portion 22a extends axially upward is arranged at an outer peripheral edge of a top surface of the lid 22b.

A yoke 23 is fixed to an outer periphery of the radial extension 22c by the deformation process. The yoke 23 is made of a magnetic material by the deformation process such as a press fit. The rotor magnet 24 is fixed to a central portion in the axial direction of an inner peripheral surface of the yoke 23. The inner peripheral surface of the rotor magnet 24 and the outer peripheral surface of the stator core 13a of the stator 13 are opposed to each other with a gap in the radial direction interposed therebetween.

3) Bearing Mechanism 30

A plurality of dynamic pressure generating grooves are formed in the outer peripheral surface of the shaft 11. By rotating the rotary unit 20 including the sleeve 21, the dynamic pressure generating grooves form a point where air pressure is increased. The rotary unit 20 is rotatably supported in the radial direction by the air pressure. Further, the rotary unit 20 is rotatably supported in the axial direction by a static pressure generated in the axial gap between an upper surface of the shaft 11 and a bottom facing surface of the lid 22b of the rotor hub 22.

An annular projection 22e is arranged at a connecting portion between the hub cylindrical portion 22a and the radial extension 22c of the rotor hub 22. A sliding seal 17 is fixed to a portion of the outer peripheral cylindrical portion 12c of the bush 12 which is opposed in the axial direction to the annular projection 22e. The sliding seal 17 prevents the rotary unit 20 from moving further downward in the axial direction.

### <Balance Correcting Structure of Rotary Unit 20>

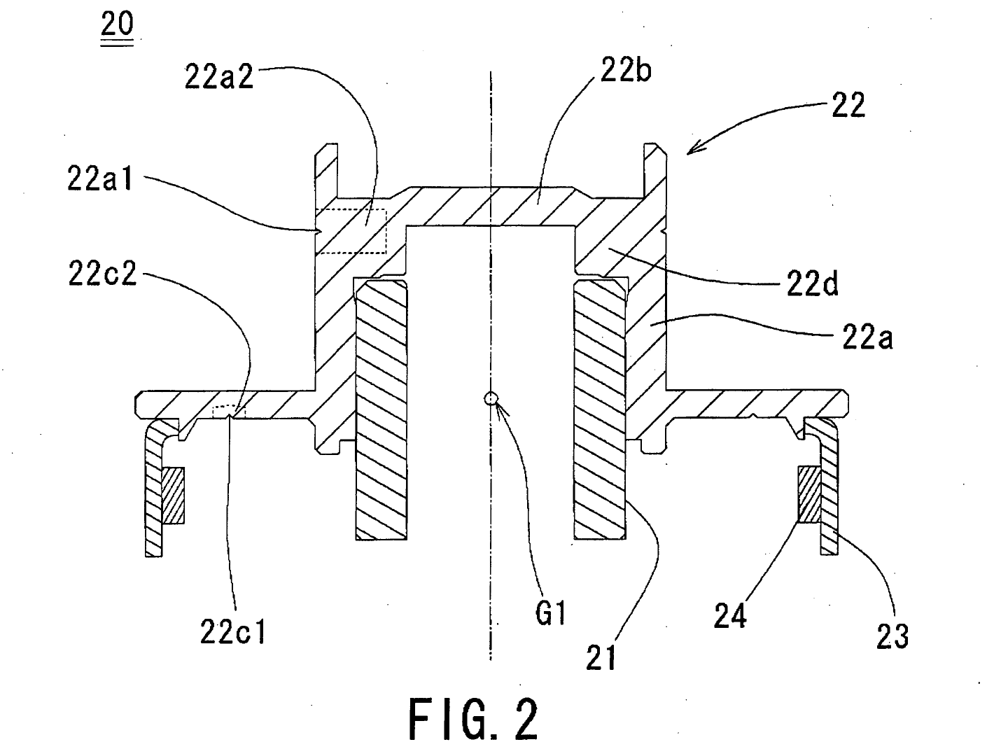

Next, a balance correcting structure of the rotary unit 20 of the present invention will be described with reference to FIG. 2. FIG. 2 is a schematic cross sectional view in the axial direction of the rotary unit 20.

Referring to FIG. 2, a peripheral surface annular groove 22a1 is formed at an upper portion in the axial direction of an outer peripheral surface of the hub cylindrical portion 22a. A position of the peripheral surface annular groove 22a1 in the axial direction is between the inner peripheral cylindrical portion 22d and the lid 22b in the axial direction. A lower surface annular groove 22c1 is formed at an outer periphery of a bottom facing surface of the radial extension 22c in the axial direction.

When the rotary unit 20 has a rotational imbalance, that is, when the balance correction for the rotary unit 20 is necessary, the balance is corrected by reducing the mass of the rotor hub 22 by using a cutting tool (not shown). When reducing the mass of the rotor hub 22, an area centering about the peripheral surface annular groove 22a1 and/or the lower surface annular groove 22c1 are drilled by the cutting tool. By virtue of such method, a cutting center of the cutting tool butts into the peripheral surface annular groove 22a1 and the lower surface annular groove 22c1, thereby determining the cutting center in the axial direction and the radial direction. Therefore, an area of the balance correction in the axial direction and radial direction with respect to a barycenter G1 is determined in accordance with working precision of the rotor hub 22. As a result, a volume to be cut in the peripheral surface annular groove 22a1 and/or the lower surface annular groove 22c1 with respect to the balance correction value is appropriately quantified. By virtue of such method, the balance can be corrected with one or two correcting operations. Thus, the operating efficiency of the balance correction is enhanced. A peripheral surface recess 22a2 centering about the peripheral surface annular groove 22a1 at which the mass of the rotor hub 22 is reduced is formed between a lower surface of the inner peripheral cylindrical portion 22d in the axial direction and an upper surface of the lid 22b in the axial direction. With this structure, since the peripheral surface recess 22a2 is formed at a location where the thickness of the hub cylindrical portion 22a in the radial direction is thick, a large amount of the mass of the rotor hub 22 can be reduced. Thus, the effect of the balance correction is improved. Further, since the peripheral surface recess 22a2 is located in the hub cylindrical portion 22a above the fixing portion of the sleeve 21 in the axial direction, and is formed above the upper end surface of the sleeve 21 in the axial direction, when the peripheral surface recess 22a2 is to be formed, the cutting tool does not come into contact with the sleeve 21 through the hub cylindrical portion 22a, and thus it is possible to prevent the sleeve 21 from being damaged, and from inclining in the radial direction by contact. Further, the peripheral surface recess 22a2 is substantially cylindrically shaped, wherein the bottom portion of the peripheral surface recess 22a2 can be cone shaped. When a small amount of the rotor hub 22 is to be cut in order to balance the rotor hub 22, the peripheral surface recess 22a2 can be cone shaped.

A lower surface recess 22c2 whose mass centering about the lower surface annular groove 22c1 is reduced is formed near the yoke 23 of the radial extension 22c. With this structure, since the lower surface recess 22c2 is provided in the outer edge of the radial extension 22c in the radial direction, an effect of centrifugal force is taken in consideration. Thus, even when a small amount of mass is reduced at the rotor hub 22 is small, an effect of the balance correction can be substantial.

Generally, when the rotational balance is deteriorated, a side of the rotary unit 20 above the barycenter G1 and that below the barycenter G1 swing in the radial direction with respect to the barycenter G1. When the rotational balance is corrected at one side in the axial direction of the barycenter G1, the balance correction is not sufficient since the balance correction is executed on only way side in the axial direction of the rotary unit. When the balance of the rotor unit 20 on one side in the axial direction with respect to the barycenter G1 is corrected, the rotational balance remains poor since the balance on the other side remains uncorrected.

According to the present invention, on the other hand, the peripheral surface recess 22a2 and the lower surface recess 22c2 are respectively formed on the upper side and the lower side in the axial direction of the barycenter G1, and therefore the balance is corrected at the upper side and the lower side with respect to the barycenter G1. Thus, the rotational balance on the upper side and the rotational balance on the lower side can be corrected, and the effect of the balance correction can be exhibited on both sides in the axial direction. As a result, since the rotary unit 20 does not swing in the radial direction with respect to the barycenter G1, a proper rotational balance is achieved.

### <Balance Correcting Structure of Motor>

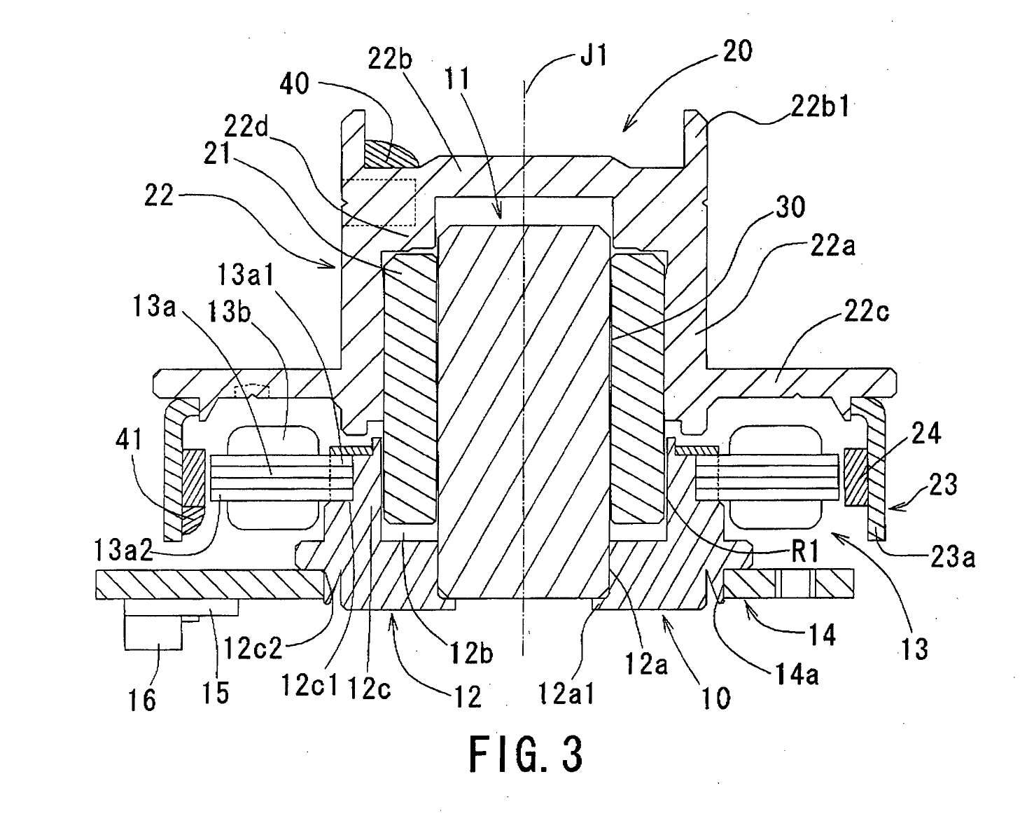

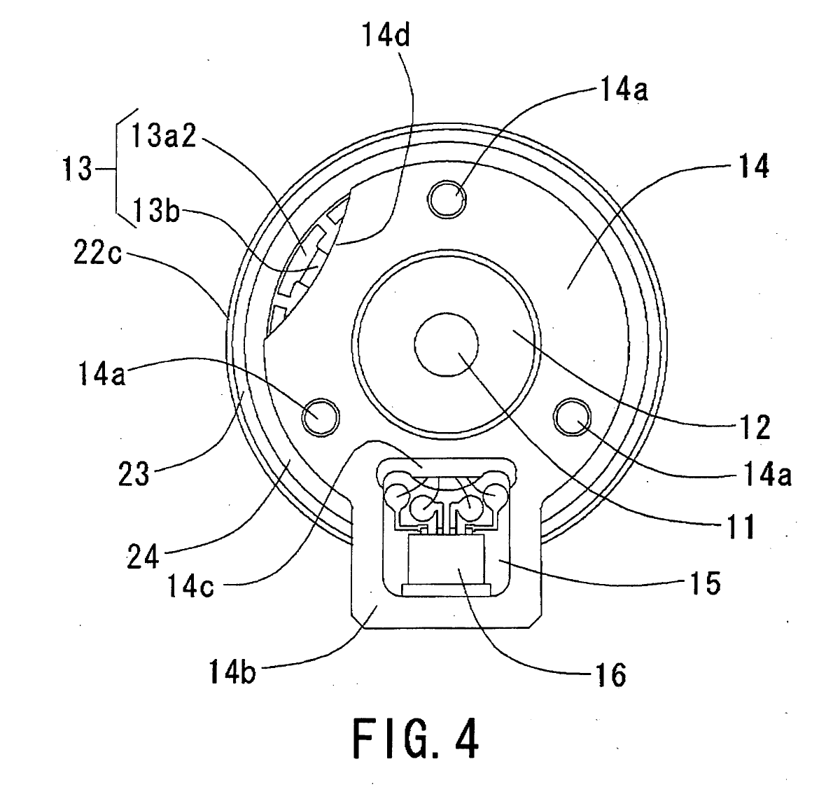

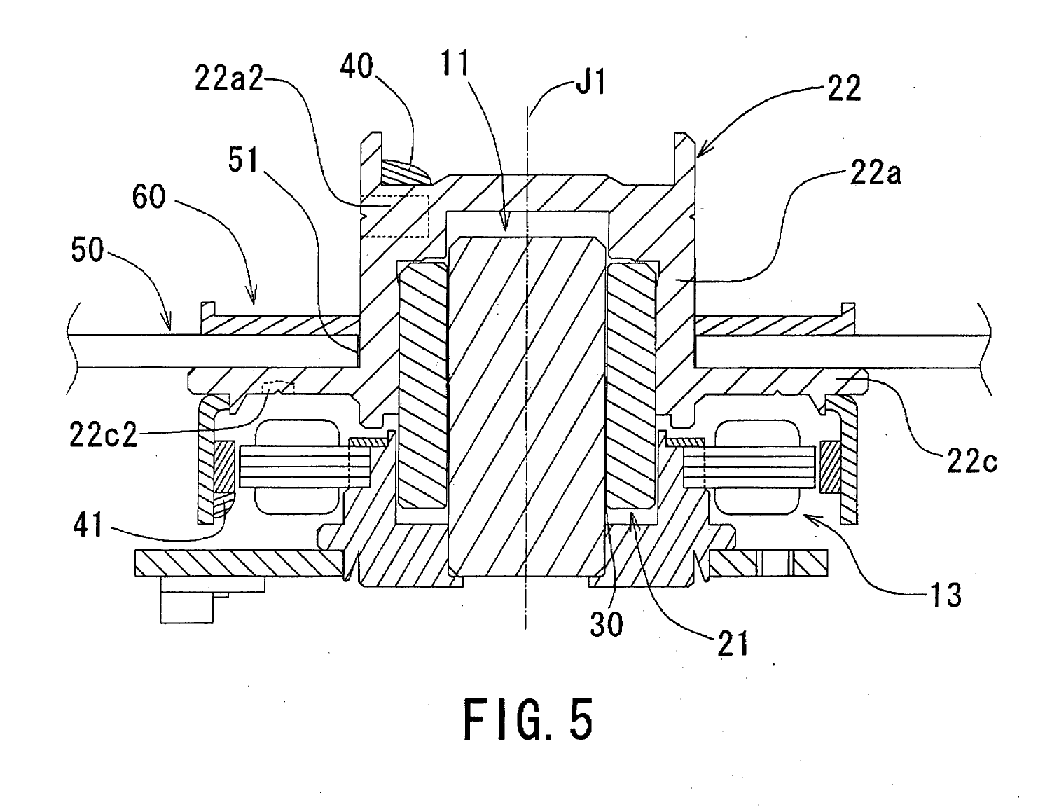

Next, the balance correction executed on the motor after the motor has been assembled will be described with reference to FIGS. 3 to 5. FIG. 3 is a schematic cross sectional view in the axial direction of a state where a balance correcting member is fixed to the motor after the motor is assembled. FIG. 4 is a bottom view of the motor of the present invention as viewed from the mounting plate 14. FIG. 5 is a schematic cross sectional view in the axial direction of a state where the balance correcting member is fixed to the motor after a color wheel is mounted.

Referring to FIG. 3, the circumferential wall 22b1 is formed on the upper surface of the lid 22b in the axial direction. A first balance correcting member 40 is fixed to the inner periphery of the circumferential wall 22b1 such that the first balance correcting member 40 abuts against the outer periphery of the upper surface of the lid 22b in the axial direction and against the inner peripheral surface of the circumferential wall 22b1. The rotational balance of the upper side of the rotary unit 20 above the barycenter G1 in the axial direction is corrected by the first balance correcting member 40. The circumferential wall 22b1 prevents the first balance correcting member 40 from moving in a centrifugal direction. Therefore, even when the motor rotates at a high speed, the first balance correcting member 40 does not jump outside from the motor. Thus, it is possible to keep the rotational balance of the motor for a long term.

A lower extension 23a extending in the axial direction below a lower end surface of the rotor magnet 24 to a lower side thereof in the axial direction is provided to the yoke 23. A second balance correcting member 41 is fixed such that it abuts against the inner peripheral surface of the lower extension 23a and the lower end surface of the rotor magnet 24 in the axial direction. The rotational balance of the rotary unit 20 in the axial direction below the barycenter G1 is corrected by the second balance correcting member 41. The lower extension 23a exhibits the same effect as that of the circumferential wall 22b1 with respect to the second balance correcting member 41.

Referring to FIG. 4, the mounting plate 14 includes mounting holes 14a (three, in this preferred embodiment) through which the mounting plate 14 is fixed to a motor mounting member (not shown). The mounting plate 14 also includes at a portion thereof where the circuit substrate 15 is arranged a circuit substrate mounting section 14b extending radially outward. The circuit substrate mounting section 14b includes near an inner peripheral edge of the circuit substrate 15 a through hole 14c which is in communication with the stator 13. A notch 14d is formed at a portion of an outer peripheral edge of the mounting plate 14. A portion of the outer periphery of the stator 13 is exposed through the notch 14d. In order to form the mounting hole 14a of the mounting plate 14, the outer peripheral edge of the mounting plate 14 is superposed on the inner peripheral surface of the rotor magnet 24 in the radial direction. Therefore, it is difficult to fix the second balance correcting member 41 in a manner that the second balance correcting member 41 abuts against the inner peripheral surface of the lower extension 23a of the yoke 23 and the lower end surface of the rotor magnet 24 in the axial direction. Therefore, a space for fixing the second balance correcting member 41 can be secured by providing the notch 14d. As a result, it becomes possible to enhance the efficiency of the fixing operation of bringing the second balance correcting member 41 into abutment against the inner peripheral surface of the lower extension 23a of the yoke 23 and the lower end surface of the rotor magnet 24 in the axial direction. Further, by virtue of the configuration, a fixing state between the second balance correcting member 41 and the yoke 23 and the rotor magnet 24 can be checked visually. Therefore, it is possible to enhance the operation efficiency of the balance correction and to enhance the reliability of the balance correction.

Referring to FIG. 5, a disc shaped color wheel 50 which rotates centering about the central axis J1 includes an opening hole 51. A color filter for each of four colors (e.g., red, blue, green and yellow) is pasted in a circumferential direction on an outer periphery of the color wheel 50. The opening hole 51 of the color wheel 50 is engaged with the outer peripheral surface of the hub cylindrical portion 22a of the rotor hub 22, and is placed on an upper surface in the axial direction of the radial extension 22c. A substantially annular shaped clamp member 60 is fixed to an upper surface in the axial direction of the color wheel 50, thereby clamping the color wheel 50.

The first balance correcting member 40 and the second balance correcting member 41 are respectively fixed to an upper side of a top surface of the rotor hub 22 in the axial direction and to a bottom facing side of the mounting plate 14 in the axial direction. Even after the color wheel 50 and the clamp member 60 are fixed to the rotor hub 22, it is possible to correct the rotational balance on the upper side and the lower side of the motor with respect to the barycenter G1. When the rotational balance of the motor is corrected after the color wheel 50 and the clamp member 60 are fixed thereto, a third balance correcting member (not shown) is used. The third balance correcting member is fixed at an inner side of an annular circumferential wall provided on an outer circumferential edge of a top surface of the clamp member 60.

Since the filters (not shown) are pasted on the outer periphery of the color wheel 50, the rotational balance in the circumferential direction and the radial direction of the color wheel 50 can be deteriorated due to a size of the filter and a mounting error thereof. Further, the rotational balance in the radial direction and the circumferential direction of the clamp member 60 may be poor due to a working error. Since the motor having arranged thereon the color wheel 50 is put use (i.e., rotates) after the color wheel 50 and the clamp member 60 are mounted thereon, the rotational balance of the motor having arranged thereon the color wheel 50 and the clamp member 60 is more important than the rotational balance of the motor alone. Therefore, it is preferable to correct the balance in a state where the color wheel 50 and the clamp member 60 are mounted on the motor.

It is not preferable to correct the balance by cutting after the motor is assembled, i.e., after the bearing mechanism 30 is formed. Firstly, the cutting at the lower surface recess 22c2 in the axial direction cannot be executed since the stator 13 is located there below in the axial direction. Secondly, a force in the radial direction to the peripheral surface recess 22a2 is applied to the hub cylindrical portion 22a when cutting the peripheral surface recess 22a2, whereby the inner peripheral surface of the sleeve 21 and the outer peripheral surface of the shaft 11 constituting the bearing mechanism 30 are brought into a strong contact with each other. Due to such contact, there is an adverse possibility that this cutting makes an indentation or a flaw on the outer peripheral surface of the shaft 11 and the inner peripheral surface of the sleeve 21. As a result, there is a possibility that seizing is generated in the bearing mechanism 30. Therefore, after the motor is assembled, it is preferable to correct the rotational imbalance by using the first balance correcting member 40 and the second balance correcting member 41.

### <Balance Correcting Method>

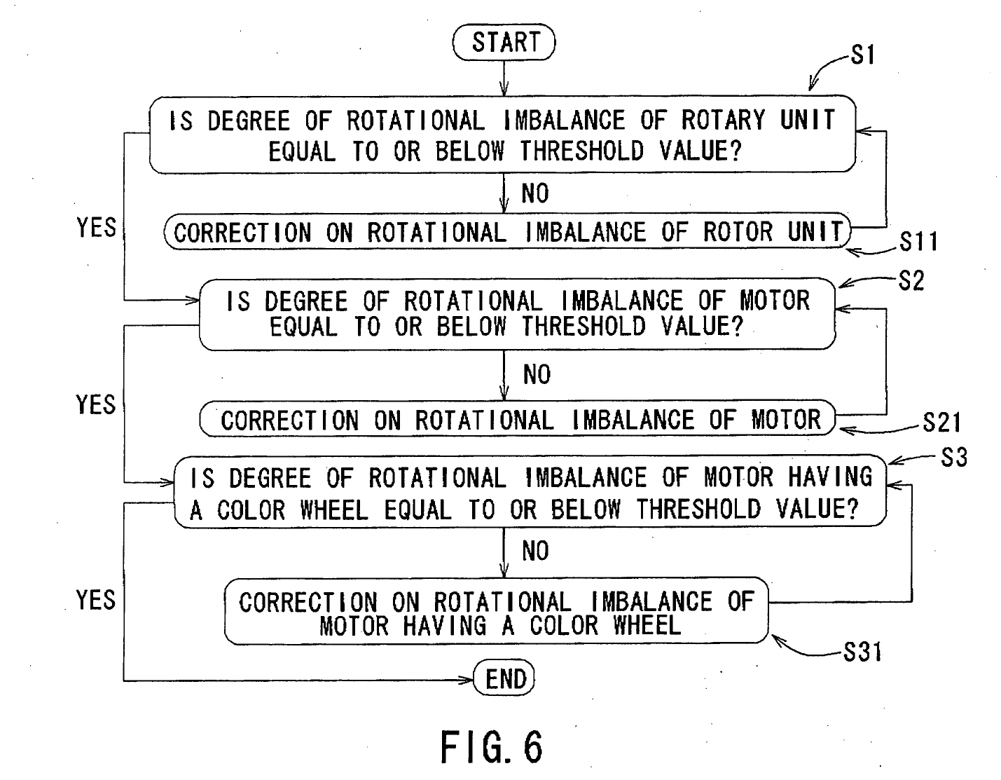

Next, the balance correcting method will be described with reference to FIG. 6. FIG. 6 is a flowchart illustrating a flow of steps of the balance correction.

Referring to FIG. 6, a state of the rotational balance of the rotary unit 20 is measured (step S1). When the rotational imbalance of the rotary unit 20 is equal to or below a predetermined threshold value of the rotary unit 20, the balance correction is not carried out. When the rotational imbalance of the rotary unit 20 is greater than the threshold value, the balance correction by cutting is carried out (step S11). The balance correction in step S11 is carried out repeatedly until the rotational imbalance of the rotary unit 20 becomes equal to or less than the threshold value.

Next, the rotary unit 20 is assembled to the stator unit 10 to complete the motor. Then, the rotational balance of this motor is measured (step S2). When the rotational imbalance is equal to or less than the predetermined threshold value rotational balance, the balance correction is not carried out. When the rotational imbalance of the motor is greater than the threshold value, the balance correction by the first balance correcting member 40 and second balance correcting member 41 is carried out (step S21). The balance correction in step S21 is carried out repeatedly until the rotational imbalance of the motor becomes equal to or less than the threshold value.

Lastly, the color wheel 50 and the clamp member 60 are mounted on the motor. Then, the rotational balance of this motor state having arranged thereon the color wheel 50 and the clamp member 60 is measured (step S3). When the rotational imbalance of the motor having arranged thereon the color wheel 50 and the clamp member 60 is equal to or less than the threshold value, the balance correction is not carried out. However, when the rotational imbalance of the motor having arranged thereon the color wheel 50 and the clamp member 60 greater than the threshold value, the balance correction by the first balance correcting member 40 and second balance correcting member 41 is carried out (step S31). The balance correction in step S31 is carried out repeatedly until the rotational imbalance of the motor having arranged thereon the color wheel 50 and the clamp member 60 becomes equal to or less than the threshold value.

While the embodiment of the present invention has been described in detail, the foregoing description is in all aspects illustrative and not restrictive. It is understood that numerous other modifications and variations can be devised without departing from the scope of the invention.

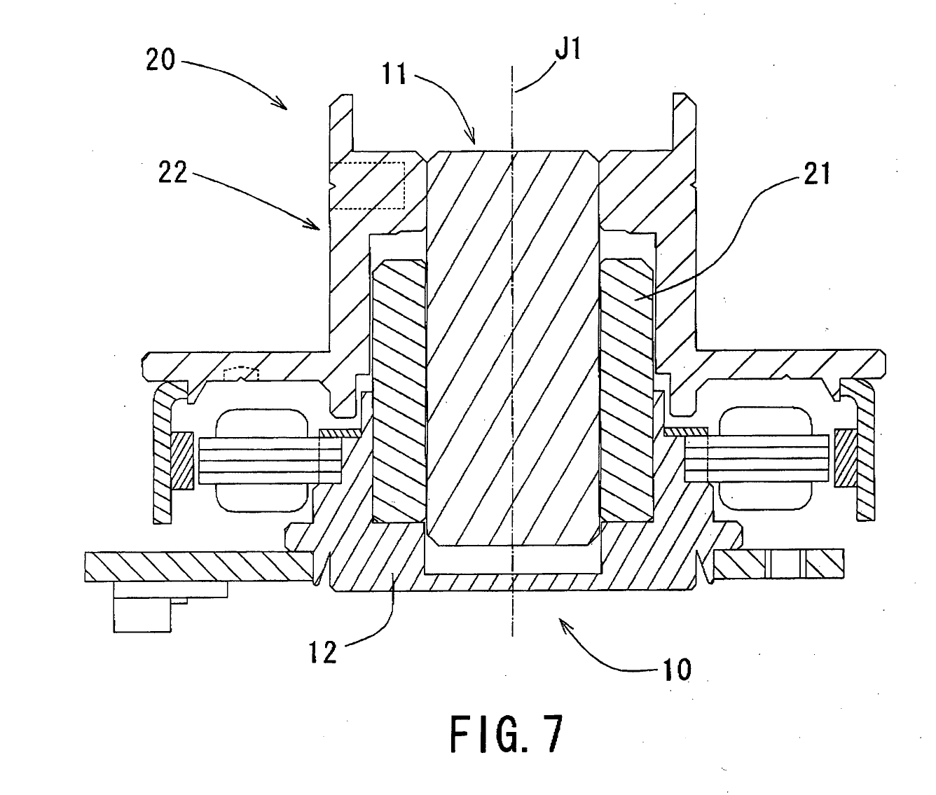

For example, although the motor according to the present invention has the structure in which the shaft 11 is fixed to the bush 12 and the sleeve 21 is fixed to the rotor hub 22, the structure of the present invention is not limited thereto. For example, as shown in FIG. 7, the shaft 11 may be fixed to the rotor hub 22 and the sleeve 21 may be fixed to the bush 12. In a motor having such structure as described above, the structure and the method of the balance correction are the same.

Further, although the bearing mechanism 30 according to the embodiment of the present invention is the gas bearing using gas such as air as a medium, the invention is not limited thereto. For example, a fluid dynamic pressure bearing in which lubricant oil is provided between the bearings may be used. Further, a magnetic bearing in which a space between bearings is supported by a magnetic force; or a rolling-element bearing which is fixed by sandwiching a ball between bearings may be used.

Although the color wheel 50 of the preferred embodiment of the present invention is fixed by the clamp member 60, the invention is not limited thereto. For example, the clamp member 60 is not always necessary.

Although the rotational balance of the rotary unit 20 and that of the motor are measured in the balance correcting method of the preferred embodiment of the present invention, the invention is not limited thereto. For example, a rotational balance of a motor only after the color wheel 50 and the clamp member 60 are mounted thereon may be measured. Further, the rotational balance of the motor alone, and the rotational balance of the motor after the color wheel 50 and the clamp member 60 are mounted thereon may be measured.

The first balance correcting member 40 and the second balance correcting member 41 of the present invention can be made of any material (e.g., harden able liquid such as adhesive) as long as they have constant masses and they are respectively fixed to the inner periphery of the circumferential wall 22b1, the lower end surface of the rotor magnet 24 in the axial direction, and the inner peripheral surface of the yoke 23.

According to the balance correction of the preferred embodiment of the present invention, a balance correction on the upper side and lower side in the axial direction of the barycenter G1 is carried out, but the invention is not limited to this. If the rotational imbalance occurs at only one side in the axial direction with respect to the barycenter G1 of a motor, the balance correction may be carried out only on the one side of the motor. The same can be applied to the rotary unit 20, and the motor having arranged thereon the color wheel 50 and the clamp member 60.

Furthermore, although the notch 14d of the mounting plate 14 is formed such that a portion of the outer periphery of the stator 13 is exposed, this is not limited thereto. For example, the notch 14d can be formed such that the lower portion of the rotor magnet 24 is exposed.

What is claimed is:

1. A motor comprising:
a rotor unit rotatable about a central axis, including,
a rotor magnet, and
a rotor hub having a notch at which a portion of the rotor hub is removed, including a hub cylindrical portion having a substantially hollow, cylindrical shape centered on the central axis, a radial extension radially outwardly extending from an axially lower portion of the hub cylindrical portion; and
a stator unit supporting the rotor unit in a rotatable manner and including a stator having a surface radially facing the rotor magnet,
wherein the notch is arranged in at least one of a radially outside surface of the hub cylindrical portion and an axially lower surface of the radial extension to correct a rotational balance of the rotor unit.

2. The motor as set forth in claim 1, wherein the notch is a portion at which the rotor hub is cut.

3. The motor as set forth in claim 2, wherein the rotor unit further includes a substantially annular groove centered on the central axis and circumferentially extending from the notch in at least one of the axially lower surface of the radial extension and the radially outside surface of the hub cylindrical portion.

4. The motor as set forth in claim 2, wherein the notch is the portion at which a substantially cylindrical part of the rotor hub is removed.

5. The motor as set forth in claim 1, wherein:
the stator unit further includes a sleeve which is arranged at a radially inside the hub cylindrical portion;
the rotor hub includes an inner peripheral cylindrical portion radially inwardly extending at an axially upper end portion of the rotor hub, a radially inner side end thereof is arranged radially inner from a radially outer end of the sleeve; and
the notch is arranged at a portion, a radially outside the inner peripheral cylindrical portion, of the radially outside surface of the hub cylindrical portion.

6. The motor as set forth in claim 1, wherein the rotor unit further includes a circumferential wall and a first balance correcting member, the circumferential wall axially upwardly extends from an radially outside portion of an axially upper end of the hub cylindrical portion of the rotor hub, and the first balance correcting member is arranged at a radially inner side of the circumferential wall to correct the rotational balance of the rotor unit.

7. The motor as set forth in claim 6, wherein the rotor unit further includes a magnet holding section and a second balance correcting member, the magnet holding section supports the rotor magnet at a radially inner side face thereof and has an axially lower end portion arranged axially lower than that of the rotor magnet, the second balance correcting member is arranged at a position near from the axially lower end portions of the magnet holding section and the rotor magnet to correct the rotational balance of the rotor unit.

8. The motor as set forth in claim 7, wherein the stator unit further includes a mounting plate having a mounting plate notch, the mounting plate is arranged an axially lower than the stator, and the mounting plate notch is a through hole axially penetrating the mounting plate arranged axially below the axially lower end portion of the magnet holding section.

9. The motor as set forth in claim 1, wherein the rotor unit further includes a magnet holding section and a second balance correcting member, the magnet holding section supports the rotor magnet at a radially inner side face thereof and has an axially lower end portion arranged axially lower than that of the rotor magnet, the second balance correcting member is arranged at a position near from the axially lower end portions of the magnet holding section and the rotor magnet to correct the rotational balance of the rotor unit.

10. The motor as set forth in claim 9, wherein the stator unit further includes a mounting plate having a mounting plate notch, the mounting plate is arranged axially lower than the stator, and the mounting plate notch is a through hole axially penetrating the mounting plate arranged axially below the axially lower end portion of the magnet holding section.

11. The motor as set forth in claim 1, wherein the stator unit rotatably supports the rotor unit by using gas dynamic pressure.

12. A manufacturing method of the motor as set forth in claim 1, comprising the steps of:
preparing the rotor unit including the rotor hub;
preparing the stator unit to support the rotor unit in the rotatable manner;
arranging the rotor unit on the stator unit such that the rotor unit is rotatable about the central axis; and
providing the notch to the rotor hub to correct the rotational balance of the rotor unit,
wherein the notch is provided to the rotor hub before the rotor unit is arranged on the stator unit.

13. The manufacturing method as set forth in claim 12 further comprising a step of providing a substantially annular groove centered on the central axis to the rotor hub, wherein the notch is provided to the rotor hub by using a cutting tool, a tip end of the cutting tool is positioned within the annular groove for providing the notch.

14. The motor as set forth in claim 1 further comprising a color wheel arranged on the rotor hub.

15. The manufacturing method of the motor as set forth in claim 14, comprising the steps of:
preparing the rotor unit including the rotor hub having a circumferential wall axially upwardly extends from a radially outside portion of an axially upper end of the hub cylindrical portion;
preparing the stator unit to support the rotor unit in the rotatable manner;
arranging the rotor unit on the stator unit such that the rotor unit is rotatable about the central axis;
providing the notch in at least one of the lower surface of the radial extension and the radially outside surface of the hub cylindrical portion to correct the rotational balance of the rotor unit;
arranging the color wheel on the rotor hub; and
arranging a first balance correcting member at the rotor hub,
wherein the notch is provided to the rotor hub before the color wheel is arranged on the rotor hub, and the first balance correcting member is arranged at radially inner side of the circumferential wall to correct the rotational balance of the rotor unit after arranging the color wheel on the rotor hub.

16. The method of manufacturing the motor as set forth in claim 15, further comprising the steps of:
providing a clamp member having a circumferential wall axially upwardly extending from radially outside portion thereof, sandwiching the color wheel with the rotor hub to fix the color wheel on the rotor hub,
arranging a third balance correcting member at a radially inner side of the circumferential wall of the clamp member to correct the rotational balance of the rotor unit.

17. The manufacturing method as set forth in claim 14, comprising the steps of:
preparing the rotor unit including the rotor hub having a circumferential wall axially upwardly extends from an radially outside portion of an axially upper end of the hub cylindrical portion and a magnet holding section supporting the rotor magnet at a radially inner side face thereof and having an axially lower end portion arranged axially lower than that of the rotor magnet;
preparing the stator unit to support the rotor unit in the rotatable manner, and including a mounting plate having a mounting plate notch axially penetrating the mounting plate;
arranging the rotor unit on the stator unit such that the rotor unit is rotatable about the central axis and the mounting plate notch is arranged axially below the axially lower end portions of the magnet holding section and the rotor magnet;
providing the notch in at least one of the lower surface of the radial extension and the radially outside surface of the hub cylindrical portion correct the rotational balance of the rotational balance of the rotor unit;
arranging the color wheel on the rotor hub; and
arranging a first balance correcting member at a radially inner side of the circumferential wall of the rotor unit,
arranging a second balance correcting member at a position near from the axially lower end portions of the magnet holding section and the rotor magnet
wherein the first balance correcting member and the second balance correcting member are arranged to correct the rotational balance of the rotor unit after arranging the color wheel on the rotor hub.

18. A motor comprising:
a rotor unit rotatable about a central axis, including,
a rotor magnet,
a rotor unit having
a hub cylindrical portion having a substantially hollow, cylindrical shape centered on the central axis,
a radial extension radially outwardly extending from the axially lower portion of the hub cylindrical portion,
a circumferential wall axially upwardly extends from an radially outside portion of an axially upper end of the hub cylindrical portion, and
a magnet holding section supporting the rotor magnet at a radially inner side face thereof and having an axially lower end portion arranged axially lower than that of the rotor magnet,
a first balance correcting member arranged at a radially inner side of the circumferential wall, and
a second balance correcting member arranged at a portion near from the axially lower end portions of the magnet holding section and the rotor magnet; and
a stator unit supporting the rotor unit in a rotatable manner and including a stator having a surface radially facing the rotor magnet,
wherein the first balance correcting member and the second balance correcting member together correct a rotational balance of the rotor unit.

19. The motor as set forth in claim 18, wherein amounting plate having a mounting plate notch, the mounting plate is arranged an axially lower than the stator, and the mounting plate notch is a through hole axially penetrating the mounting plate arranged axially below the second balance correcting member.

20. The motor as set forth in claim 18, wherein the rotor unit further includes:
a color wheel arranged on the rotor hub;
a clamp member having a circumferential wall axially upwardly extending from a radially outside portion thereof, sandwiching the color wheel with the rotor hub to fix the color wheel on the rotor hub; and
a third balance correcting member arranged at a radially inner side of the circumferential wall of the clamp member to correct the rotational balance of the rotor unit.

21. The motor as set forth in claim 18, wherein the stator unit rotatably supports the rotor unit by using gas dynamic pressure.
